(19) United States
(12) Patent Application Publication
(10) Pub. No.: US 2003/0161995 A1
(43) Pub. Date: Aug. 28, 2003

(54) Variable porosity barrier sheet and disposable garment incorporating same

(76) Inventors: Michael Kauschke, Rimsting (DE); Mordechai Turi, Princeton Junction, NJ (US)

Correspondence Address: Neal L. Rosenberg, Esq., AMSTER, ROTHSTEIN & EBENSTEIN, 90 Park Avenue, New York, NY, 10016, US

(21) Appl. No.: 10/086,532

(22) Filed: Feb. 28, 2002

(51) Int. Cl. B32B 3/10

(52) U.S. Cl. 428/138; 428/137

(57) ABSTRACT

A barrier sheet for use in diapers, surgical gowns and the like wherein the goals of comfort and barrier protection are balanced through the use of a barrier sheet affording a variable porosity achieved by use of a liquid-expandable material.

### BACKGROUND OF THE INVENTION

The present invention relates to a barrier sheet and a disposable garment incorporating the same, and more particularly to such a barrier sheet/disposable garment exhibiting a variable porosity.

The term “comfortable barrier sheet” is an oxymoron. A prime factor in determining the wearing comfort of a garment incorporating a barrier sheet is the breathability (also called “permeability”) of the sheet, typically measured by the moisture vapor transmission rate thereof and/or by the air permeability thereof. Flexibility, weight, softness, drapability, hand, and other parameters or characteristics usually associated with wearing apparel also enter into the definition of comfort. The barrier property (also called “liquid transmission resistance”) is determined by the ability of the barrier sheet to withstand a splash or “insult” of liquid without the liquid being able to penetrate the barrier sheet—that is, its liquid impermeability. Depending upon the particular application for which the barrier sheet is intended, the liquid may be urine (for example, where the application is as a diaper backsheet or cuff), blood (for example, where the application is as a surgical drape or gown), alcohol, water or the like. As the liquid insult is typically delivered to a protective garment with a certain amount of pressure behind the liquid—whether it be blood pressure, kidney pressure or simply the weight of the wearer forcing the liquid against the barrier sheet—a prime factor in determining the liquid barrier property is the ability of the garment incorporating the barrier sheet to withstand the liquid insult delivered with a particular force, typically measured by a hydrostatic head test.

On the other hand, the ability of the barrier sheet to exhibit its “barrier property” is of greater import than the ability of the barrier sheet to exhibit its “comfort property.” Thus, the prime function of a barrier sheet is to provide the requisite leakproof barrier when needed, thereby keeping potentially disease-carrying blood away from the surgeon and odorous urine away from the caregiver and any bedding, furniture or the like. In most applications, the garment containing the barrier sheet is replaced by a fresh garment shortly after the liquid insult. Thus, the comfort properties of the barrier sheet after the initial insult are of only minor concern, as typically the garment incorporating the barrier sheet—whether it be a urine-wetted diaper or a blood-soiled surgical gown—will hopefully be relatively promptly replaced by a fresh one.

Accordingly, it is an object of the present invention to provide a barrier sheet which affords a high level comfort and a high level of barrier protection.

Another object is to provide such a barrier sheet which in one embodiment provides a high level of comfort prior to a liquid insult and a high level of barrier protection upon and after the liquid insult.

A further object is to provide such a barrier sheet which in one embodiment demonstrates a variable porosity.

It is also an object of the present invention to provide such a barrier sheet which in one embodiment is simple and economical to manufacture and use.

It is a further object to provide in one embodiment a disposable garment incorporating such a barrier sheet.

### SUMMARY OF THE INVENTION

It has now been found that the above and related objects of the present invention are obtained in a barrier sheet having a porosity that varies before and after a liquid insult or a disposable garment including the same. There are three preferred embodiments of the invention. In the first preferred embodiment the barrier sheet has three layers; in the second preferred embodiment the barrier sheet has only two layers; and in the third preferred embodiment a disposable garment includes a barrier sheet having a single layer formed by only two materials.

In the first preferred embodiment, the barrier sheet comprises a first outer layer of breathable material, a second outer layer of breathable material, and a layer of material disposed intermediate the first and second outer layers. At least one of the first and second outer layers defines liquid-permeable pores therethrough. The intermediate layer is three dimensionally expandable upon exposure to a liquid insult to form a layer of material blocking the pores of at least one of the first and second outer layers and increasing the liquid transmission resistance of the sheet in the direction of and in the area of liquid insult. The first and second outer layers are secured together with the intermediate layer therebetween. The intermediate layer, prior to exposure to liquid, has a basis weight no greater than one of 15 grams per square meter (gsm) or 10% of the basis weight of the entire barrier sheet prior to exposure to liquid. The sheet, prior to exposure to liquid, is characterized by a permeability of at least one of a moisture vapor transmission rate (MVTR) of at least 500 gsm per 24 hours and an air permeability of at least 10 standard cubic feet per minute (scfm) per square foot.

In the first preferred embodiment, the distal outer layer is the last of the outer layers to be exposed to liquid and defines liquid-permeable pores therethrough. After exposure to liquid in a given area thereof, a substantial proportion of the pores of the distal outer layer in the given area may also be infiltrated and clogged against liquid passage therethrough by portions of the intermediate layer. The distal outer layer is in immediate physical contact with the intermediate layer, and preferably essentially the entire adjacent surfaces of the distal outer layer and the intermediate layer are in immediate physical contact.

In the second preferred embodiment, the barrier sheet consists of a first layer of breathable material defining liquid-permeable pores therethrough, and a second layer of material disposed on and secured to the first layer. The second layer is three dimensionally expandable upon exposure to a liquid insult to form a layer of material blocking the pores of the first layer and increasing the liquid transmission resistance of the sheet in the direction of and at the point of liquid insult. The second layer, prior to exposure to liquid, has a basis weight no greater than one of 15 gsm or 10% of the basis weight of the entire barrier sheet prior to exposure to liquid. The sheet prior to exposure to liquid is characterized by a permeability of at least one of an MVTR of at least 500 gsm per 24 hours and an air permeability of at least 10 scfm per square foot.

In the second preferred embodiment, the first layer is the last of the layers to be exposed to liquid. After exposure to liquid in a given area thereof, a substantial proportion of the pores of the first layer in the given area is presumably infiltrated and clogged against liquid passage therethrough by portions of the second layer. The first layer is in immediate physical contact with the second layer, and preferably essentially the entire adjacent surfaces of the first layer and the second layer are in immediate physical contact.

In the third preferred embodiment, the barrier sheet comprises a first material which is breathable and defines liquid-permeable pores therethrough, and a second material which is three dimensionally expandable upon exposure to a liquid insult to form a layer of material blocking the pores of the first material and increasing the liquid transmission resistance of the sheet in the direction of and at the point of liquid insult. The second material is disposed in the first material and, prior to exposure to liquid, has a weight per unit area no greater than one of 15 gsm or 10% of the basis weight of the entire barrier sheet prior to exposure to liquid. The sheet prior to exposure to liquid is characterized by a permeability of at least one of an MVTR of at least 500 gsm per 24 hours and an air permeability of at least 10 scfm per square foot.

In the third preferred embodiment, the second material is preferably at least partially disposed adjacent the surface of the first material to be initially exposed to liquid (i.e., the proximal surface) and relatively remote from the opposite surface of the first material (i.e., the distal surface). After exposure to liquid in a given area, a substantial proportion of such pores of the first material in the given area is presumably infiltrated and clogged against liquid passage therethrough by portions of the second material. The first and second materials are in immediate physical contact. Alternatively, the second material may be disposed throughout the first material.

In each of the three preferred embodiments, the barrier sheet preferably has a hydrohead of at least 10 millibars in one direction. In the first preferred embodiment, the barrier sheet has a hydrohead which is at least 25% (preferably at least 35%) greater than the hydrohead of a barrier sheet consisting of the first and second outer layers secured together without the intermediate layer. In the second preferred embodiment, the barrier sheet has a hydrohead which is at least 25% (preferably at least 35%) greater than the hydrohead of the first layer without the second layer. In the third preferred embodiment, the barrier sheet has a hydrohead which is at least 25% (preferably at least 35%) greater than the hydrohead of the first material only.

In each of the three preferred embodiments, preferably the barrier sheet is flexible. Prior to exposure to liquid, it is characterized by a permeability of at least one of an MVTR of about 500-5,000 gsm per 24 hours and an air permeability of about 10-1,000 scfm per square foot. After exposure to liquid, the formed layer is either an essentially continuous, film-like, and substantially liquid-impermeable or discontinuous.

The outer layers of the first preferred embodiment, the first layer of the second preferred embodiment and the first material of the barrier sheet of the third preferred embodiment are preferably selected from the group consisting of wovens, nonwovens, microporous films, and combinations thereof, a meltblown nonwoven being preferred (for at least one of the outer layers of the first preferred embodiment, and preferably both outer layers).

The intermediate layer of the first preferred embodiment, the second layer of the second preferred embodiment, and the second material of the third preferred embodiment are preferably discontinuous and optimally formed of particles or fibers. They are preferably a super-absorbent polymer which expands to form a gel-like layer upon exposure to liquid. They may be formed of a liquid-expandable material selected from the group consisting of starch, gelatin, viscose, pulp, cotton, polymers, and combinations thereof, whether in particle or fiber form. They are essentially instantaneously expandable upon exposure to liquid and capable of expanding in volume by a factor of at least 2 (and preferable 2-1000) upon exposure to sufficient liquid. They have a basis weight no greater than one of 15 gsm or 10% of the basis weight of the entire barrier sheet prior to exposure to liquid (typically no greater than one of 10 gsm or 5%, preferably no greater than one of 5 gsm or 4%, more preferably no greater than one of 3 gsm or 2%, and optimally no greater than one of 2 gsm or 1%).

The outer layers of the first preferred embodiment and the first and second layers of the second preferred embodiment are secured together, for example, by an adhesive (preferably elastic and in the form of a discontinuous layer) or by fusion bonding. In the third preferred embodiment, the second material is secured to the first material or the two materials are secured together by fusion bonding, with the second material optimally being dispersed within the first material.

The present invention further encompasses a barrier sheet characterized by a variable level of breathability, the breathability of the barrier sheet substantially decreasing in a given area upon a liquid insult to the barrier sheet in the given area. The breathability of the barrier sheet is determined by the MVTR thereof and/or the air permeability thereof. Preferably the barrier sheet prior to exposure to liquid is characterized by a permeability of at least one of an MVTR of at least 500 gsm/24 hours and an air permeability of at least 10 scfm/square foot, and upon exposure to liquid is characterized by a permeability of at least one of an MVTR of no more than 1,000 gsm/24 hours and an air permeability of no more than 10 scfm/square foot. The barrier sheet has a hydrohead of at least 10 millibars in the direction of liquid insult.

In a first preferred embodiment thereof the layer of material disposed intermediate the first and second outer layers is three dimensionally expandable upon exposure to a liquid insult to form a layer of material blocking the pores of at least one of the first and second outer layers and increasing the liquid transmission resistance of the sheet in the direction of and at the point of liquid insult. In a second preferred embodiment thereof the second layer of material disposed on and secured to the first layer is three dimensionally expandable upon exposure to a liquid insult to form a layer of material blocking the pores of the first layer and increasing the liquid transmission resistance of the sheet in the direction of and at the point of liquid insult. In a third preferred embodiment a durable garment has a second material which is three dimensionally expandable upon exposure to a liquid insult to form a layer of material blocking the pores of the first layer and increasing the liquid transmission resistance of the sheet in the direction of and at the point of liquid insult.

### BRIEF DESCRIPTION OF THE DRAWING

The above and related objects, features and advantages of the present invention will be more fully understood by reference to the following detailed description of the presently preferred, albeit illustrative, embodiments of the present invention when taken in conjunction with the accompanying drawing wherein:

FIGS. 1A and 1B are fragmentary isometric views, partially in section, of a barrier sheet according to the first preferred embodiment of the present invention before and after a liquid insult, respectively;

FIGS. 2A and 2B are fragmentary sectional views of a barrier sheet according to the first preferred embodiment of the present invention before and after a liquid insult, respectively;

FIGS. 3A and 3B are fragmentary sectional views of a barrier sheet according to the second preferred embodiment of the present invention before and after a liquid insult, respectively;

FIGS. 4A and 4B are fragmentary sectional views of a disposable garment including a barrier sheet according to the third preferred embodiment of the present invention before and after a liquid insult, respectively; and

FIGS. 5A and 5B are fragmentary sectional views, to an enlarged scale, of the barrier sheet of the first preferred embodiment before and after a liquid insult, respectively, according to a presumed mechanism.

### DETAILED DESCRIPTION OF THE PREFERRED EMBODIMENTS

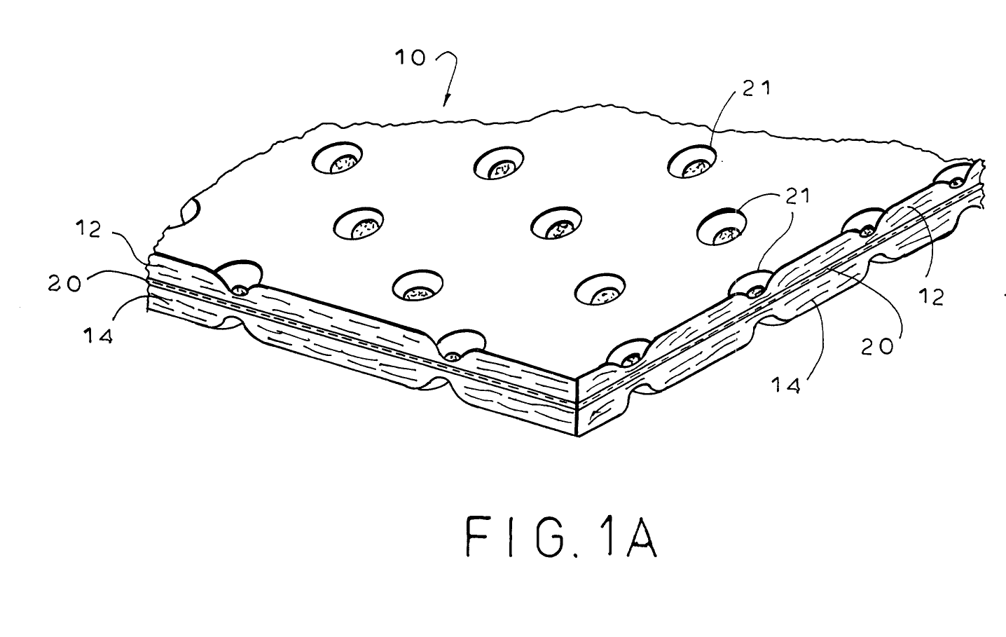

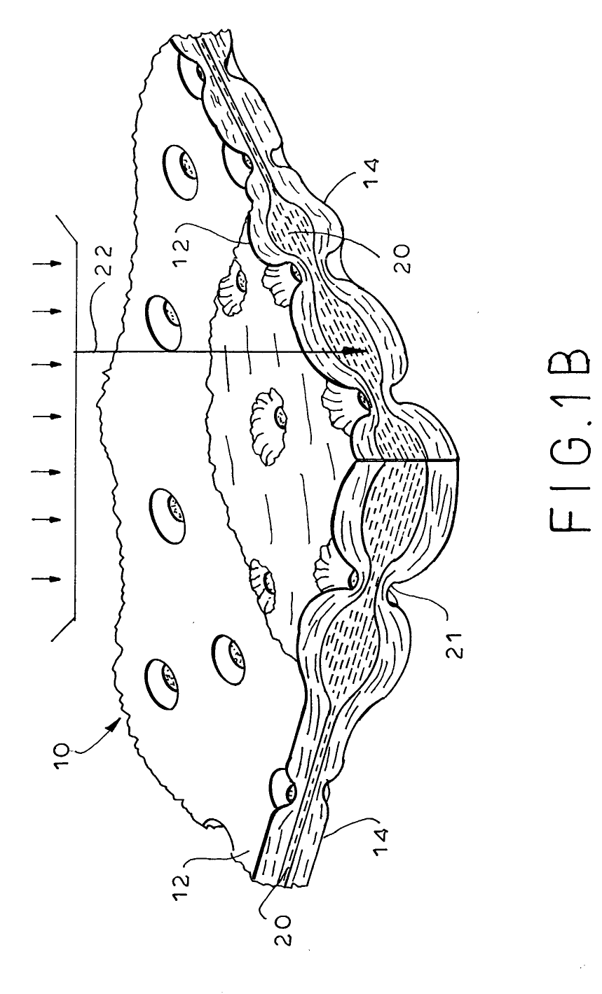

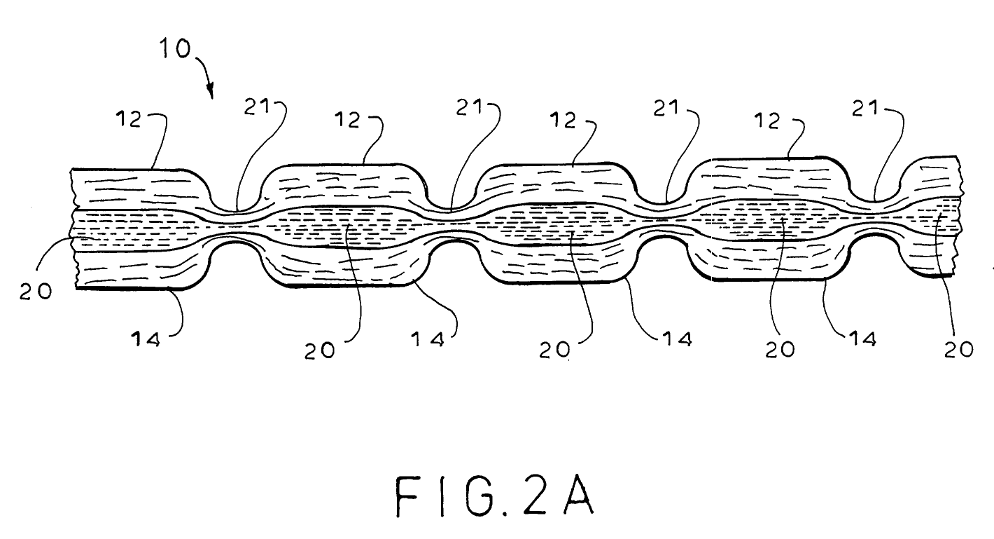

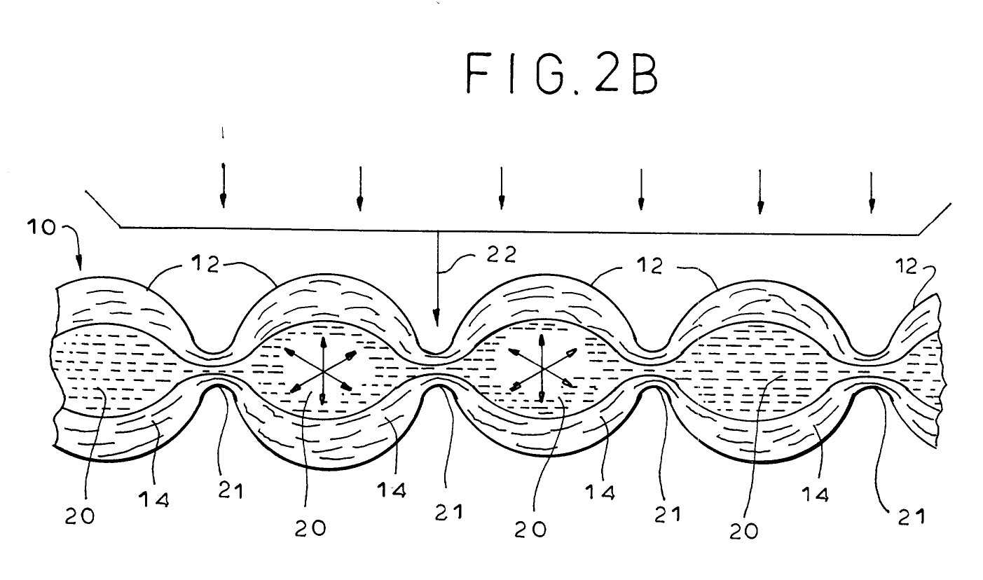

Referring now to the drawing, and in particular to FIGS. 1A through 2B thereof, therein illustrated is a barrier sheet according to a first preferred embodiment of the present invention, generally designated by the reference numeral 10. The barrier sheet 10 comprises a first outer layer 12 of breathable material (illustrated as the top layer), a second outer layer 14 of breathable material (illustrated as the bottom layer), and a layer 20 of material disposed intermediate the first and second outer layers 12, 14.

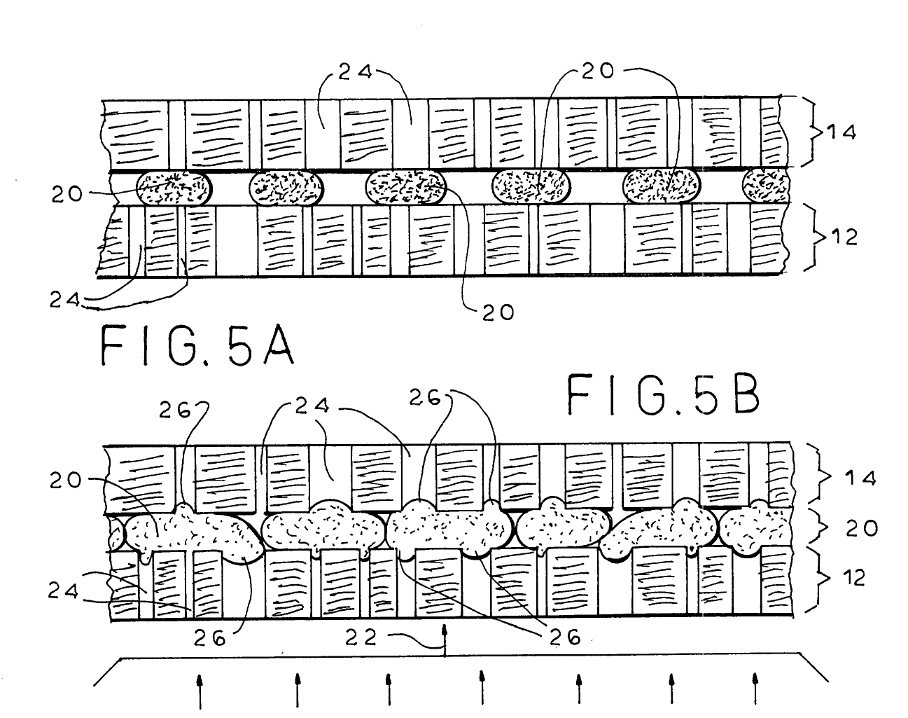

Preferably the breathable outer layers 12, 14 define liquid-permeable pores 24 therethrough (see FIG. 5) and are independently selected from the group consisting of wovens, nonwovens, microporous films, and combinations thereof. The nonwoven may be formed of meltblown, spunbond, and/or carded fibers. Optimally at least one of the outer layers 12, 14 is a meltblown nonwoven, and typically both of the outer layers 12, 14 are meltblown nonwovens.

The first and second outer layers 12, 14 are secured together with the intermediate layer 20 therebetween. The outer layers 12, 14 are secured together either directly or indirectly via the intermediate layer 20. The outer layers 12, 14 may be secured together at bonding points 21, for example, by an elastic (i.e., non-brittle) adhesive (not shown), such as a hot melt adhesive (available from Henkel under the trade name HM-6990), by fusion bonding (e.g., ultrasonic welding, or thermobonding), etc. When an elastic adhesive is used, it is preferably in the form of a discontinuous layer and hydrophobic in nature.

The intermediate layer 20 is formed of a liquid-expandable material selected from the group consisting of starch, gelatin, viscose, pulp, cotton, water-insoluble polymers or combinations thereof. Preferred liquid-expandable materials are the super-absorbent polymers which, upon exposure to liquid, absorb at least a portion of the liquid to expand three dimensionally and form a substantially liquid impermeable gel or hydrogel.

Preferably, the intermediate layer 20 is formed of particles, fibers, or the like. If formed of particles, it is discontinuous; if formed of fibers, it is a porous continuous layer of entangled fibers. It is capable of expanding in volume by a factor of at least 2, and preferably 2 to 1,000, upon exposure to sufficient liquid. The intermediate layer 20 is a thin layer of solid material which is essentially instantaneously expandable (for all practical purposes) upon exposure to liquid. In any case, the intermediate layer 20 is three dimensionally expandable upon exposure to a liquid insult 22 to block the pores 24 of at least one of the first and second outer layers 14 and to increase the liquid transmission resistance of the barrier sheet 10 in the direction of and in the area of liquid insult 22. Where the intermediate layer 20 is formed of a super-absorbent polymer, it expands to form a hydrogel or gel-like material upon exposure to liquid. The expanded intermediate layer 20 is preferably continuous, but may be discontinuous.

Because the intermediate layer 20 is not being used in the present invention as a liquid-absorbent or liquid-adsorbent material per se, only a relatively small amount of the intermediate layer 20 is required. Thus, the intermediate layer 20, prior to exposure to liquid, has a basis weight no greater than 15 gsm. It typically has a basis weight no greater than 10 gsm, preferably no greater than 5 gsm, more preferably no greater than 3 gsm, and optimally no greater than 2 gsm. Alternatively, the intermediate layer 20, prior to exposure to liquid, has a basis weight no greater than 10% of the basis weight of the sheet 10 prior to exposure to liquid. It typically has a basis weight no greater than 5% of the basis weight of the sheet 10 prior to exposure to liquid, preferably no greater than 4%, more preferably no greater than 2%, and optimally no greater than 1%. It will be appreciated that in determining the basis weight of the sheet 10, only the outer layers 12, 14 in direct and immediate physical contact with the intermediate layer 20 are taken into consideration, and not any additional layers which may be more remotely situated from the intermediate layer 20 (e.g., in a garment incorporating the barrier sheet).

It appears that the absolute basis weight limitation (e.g., 15 gsm) is of greater significance than the percentage basis weight limitation (e.g., 10% of the basis weight of the sheet). Accordingly, it is preferred that the intermediate layer meet the absolute weight limitation, even if it does not also meet the percentage basis weight limitation. However, an intermediate layer which meets the percentage basis weight limitation may also be useful in the present invention even though it does meet the absolute basis weight limitation. Nonetheless, desirably both the absolute basis weight limitation and the percentage basis weight limitation are met.

Because the liquid-expandable intermediate layer 20 is not being employed for its ability to absorb or adsorb the liquid insult, a barrier sheet according to the present invention is capable of providing protection essentially without regard to the quantity of the liquid insult above the minimum necessary to provide sufficient three dimensional expansion sufficient to block the pores and increase the liquid transmission resistance of the barrier sheet in the direction of and in the area of liquid insult.

The liquid-expandability of the material 20 may result from a number of different mechanisms, whether taken alone or in combination. For example, the material 20 may absorb the liquid (an internal phenomenon) or merely adsorb the liquid (a surface phenomenon); it may simply swell due to the presence of a liquid or actually form a gel or gel-like material.

The comfort of the barrier sheet 10 derives from the fact that, prior to exposure to liquid, it is characterized by a permeability of at least one of an MVTR of at least 500 gsm per 24 hours and an air permeability of at least 10 scfm per square foot. (By way of contrast, upon exposure to liquid the barrier sheet 10 is characterized by a permeability of at least one of an MVTR of no more than 1,000 gsm/24 hours and an air permeability of no more than 10 scfm/square foot.) More particularly, prior to exposure to liquid, the sheet is preferably characterized by a permeability of at least one of an MVTR of about 500-5,000 gsm per 24 hrs and an air permeability of about 10-1,000 scfm per square foot. The high permeability is a significant factor in providing comfort to the wearer. The relatively small amount of the intermediate layer typically results in a barrier sheet which is flexible, and typically drapable and lightweight, factors customarily also taken into consideration in determining the comfort of wearing apparel.

On the other hand, upon exposure to liquid—as in the static hydrohead test—the barrier sheet exhibits a hydrohead of at least 10 millibars in at least one direction—namely, the direction of liquid flow or insult (as illustrated by arrow 22 of FIG. 1B)—and in many instances in both directions. This hydrohead is at least 25% (preferably at least 35%) greater than the hydrohead of a hypothetical second barrier sheet consisting of the first and second outer layers 12, 14 secured together without the intermediate layer 20. Thus, precisely at the time when liquid impermeability is most needed (immediately upon the liquid insult), the barrier sheet 10 provides the desired high level of protection against liquid penetration, even to reasonably anticipatable liquid pressures which might be encountered by a diaper or a surgical gown or drape—namely, the weight of a child or the pressure of blood flow.

After exposure to liquid, the now non-breathable barrier sheet or portion thereof may be replaced. Where the liquid insult does not involve the entire surface area of the barrier sheet, but only a relatively minor portion of the surface area, the loss in breathability in the area of the insult may not affect the overall comfort of the garment containing the barrier sheet so that replacement of the garment can be postponed without the wearer even noticing the local loss of permeability.

The barrier sheet 10 has many applications in fields where initially the breathability property of the barrier sheet may be of major importance (e.g., for comfort of the wearer), but, upon exposure to liquid, the barrier property becomes of primary importance. For example, the barrier sheet provides a superior cloth-like feel (relative to the feel of a water-impermeable film) and thus may find utility as a diaper backsheet where breathability is a major initial concern (for comfort of the baby) but is trumped after a urine discharge by the need for urine impermeability (for the protection of caregiver, bedding, furniture and the like) until the diaper can be changed. While many of these applications are in the field of wearing apparel (e.g., diapers, feminine hygiene products, protective gear, wound dressings, bandages, surgical gowns, and the like), there are also applications in other fields (such as health care, breathable packaging, and the like).

As noted, the barrier sheets according to the present invention find utility in a wide variety of applications. Each of the embodiments thereof is particularly useful as part of a disposable garment. As used herein, the term “disposable garment” is defined broadly and includes diapers, incontinence pads and catamenial pads (e.g., the outwardly-facing surface or back sheet, etc.), surgical drapes and gowns (the former being typically placed or draped over a portion of a surgical patient while the latter is typically worn by the surgical personnel), wound dressings and bandages, protective gear, etc. Generally, the term encompasses any sheet used to cover any portion of a living entity, thereby to provide protection against a liquid insult of water, urine, blood, alcohol, or the like, and then disposed of.

It is instructive to note that the barrier sheet 10 always exhibits a high hydrohead test value (at least when the liquid-expandable intermediate layer 20 is upstream of the breathable distal outer layer 14). Because the standard hydrohead test involves exposure of the test sheet to liquid, the barrier sheet 10 always exhibits the high hydrohead normally associated with a lack of breathability. In effect, the hydrohead is always measured after exposure of the barrier sheet to liquid. By way of contrast, the actual porosity of the barrier sheet—whether measured by MVTR or air permeability—varies. The standard permeability tests for these values are performed on a dry barrier sheet so that the test values are high. Yet, in practice, once the barrier sheet has been exposed to liquid, it in fact exhibits a very low permeability or becomes substantially impermeable in the direction of and in the area of exposure to the liquid (whether measured by MVTR or air permeability). Thus the present invention addresses the need for both comfort and protection, providing the former for as long as possible, but sacrificing the same in favor of the latter only when the need for protection arises.

The mechanism by which the liquid-expandable intermediate layer 20 provides the barrier property (i.e., substantial liquid impermeability) to the barrier sheet 10 is not completely understood. The relatively small amount of the intermediate layer 20 required to provide the desired liquid transmission resistance is a basis weight no greater than one of 15 gsm or 10% of the basis weight of the barrier sheet 10 prior to exposure to liquid, and preferably not greater than either. This precludes the use of the intermediate layer 20 as a liquid-absorbent or liquid-adsorbent material per se.

Clearly the expanded intermediate layer 20 blocks the transmission of liquid into and through the pores of the downstream outer layer 14. According to one possible mechanism, this is the result of the formation of a liquid-blocking layer per se which overlies the pores and prevents the passage of liquid into the pores, without the material of the expanded intermediate layer actually infiltrating or entering into such pores. On the other hand, according to another possible mechanism, one or more of the major surfaces of the expanded intermediate layer form dangling protrusions, fibrils or string-like portions which extend into, infiltrate and clog the pores of the distal or downstream outer layer (and optimally the pores of both outer layers). Without limiting the scope of the present invention, the latter mechanism is theoretically presumed to be the one operable in the present invention as it explains how such a high barrier property is achieved with such a low quantity of the liquid-expandable intermediate layer. It is recognized, however, that the presumed mechanism may be applicable only where the liquid-expandable material of the intermediate layer is a superabsorbent polymer or like material which forms a gel, hydrogel, or gel-like material upon exposure to liquid, and that a different mechanism may be applicable where the liquid-expandable intermediate layer 20 does not form such a gel, hydrogel or gel-like material upon exposure to liquid.

Referring now to FIGS. 5A and 5B in particular, the following paragraphs illustrate the operation of the barrier sheet 10 according to the presumed mechanism described above. As this mechanism is only presumed operable in the barrier sheet, the following paragraphs should not be taken as a limitation on the scope of the present invention:

The expanded intermediate layer 20 (whether or not gel-like) defines dangling protrusions, fibrils or string-like portions of the expanded intermediate layer 20, herein identified as tendrils 26, as best seen in FIG. 5B. The gel-like tendrils 26 extend into, infiltrate and clog the pores 24 of a distal or downstream outer layer 14, and optimally the pores 24 of both outer layers 12, 14. The pores 24 are generally open cells forming channels for the passage of liquid therethrough. The pores of concern to the present invention are, of course, the pores which extend, either directly or indirectly (i.e., functionally), through the thickness of the outer layer 14.

The intermediate layer 20 is expandable into the liquid-permeable pores 24 of at least one of the first and second outer layers 12, 14 (and preferably both) upon exposure to liquid. More particularly, where the liquid flow of the insult is in the direction of arrow 22, the distal outer layer 14 is the last of the outer layers 12, 14 to be exposed to liquid and defines liquid-permeable pores 24 therethrough. The distal outer layer 14 and the intermediate layer 20 are in immediate physical contact, and preferably essentially the entire adjacent surfaces of the distal outer layer 14 and the intermediate layer 20 are in immediate physical contact. After exposure to liquid in a given area of the barrier sheet 10, a substantial proportion of the pores 24 of the distal outer layer 14 in the given area are infiltrated and clogged against liquid passage therethrough by the tendrils 26 of the expanded intermediate layer 20.

Tendrils 26 of the liquid-expanded material 20 extend into, infiltrate and clog the pores 24 of the distal outer layer 14 for two reasons. First, the force of the liquid insult carries peripheral portions of the expanded intermediate layer 20 downstream into pores 24 of the distal outer layer 14, thereby creating a number of the tendrils 26. Second, the volumetric expansion of the intermediate layer 20 (especially when limited on the upstream or proximal side by another layer) forces peripheral portions thereof into the pores 24 of the distal outer layer 14, thereby creating the tendrils 26. These forces are sufficient to enable the nascent tendrils 26 to penetrate any discontinuous layer of elastic adhesive between such expanded layer 20 and the pores 24 of the distal outer layer 14, thus clogging the pores 24 and creating a liquid barrier.

The extent of the infiltration of the liquid-permeable pores 24 of the distal outer layer 14 by the tendrils 26 of the expanded intermediate layer 20 (after exposure to liquid) may be minimal. All that is required is that there be sufficient penetration of the pores 24 by the tendrils 26 such that the tendrils 26 clog the pores 24 and rendered some cross section thereof non-liquid-permeable.

The true function of the intermediate layer 20 is to expand upon exposure to liquid so that, after exposure to liquid in a given area thereof, a substantial proportion of the pores 24 of the distal outer layer 14 in the given area is infiltrated and clogged against liquid passage therethrough by portions of the intermediate layer 20 (i.e., the tendrils 26). Thus the barrier properties arise not out of the presence of the expanded intermediate layer 20 between the outer layers 12, 14, but rather from the tendrils 26 of the expanded intermediate layer 20 having infiltrated the pores 24 of the distal outer layer 14, thereby clogging them against liquid passage therethrough.

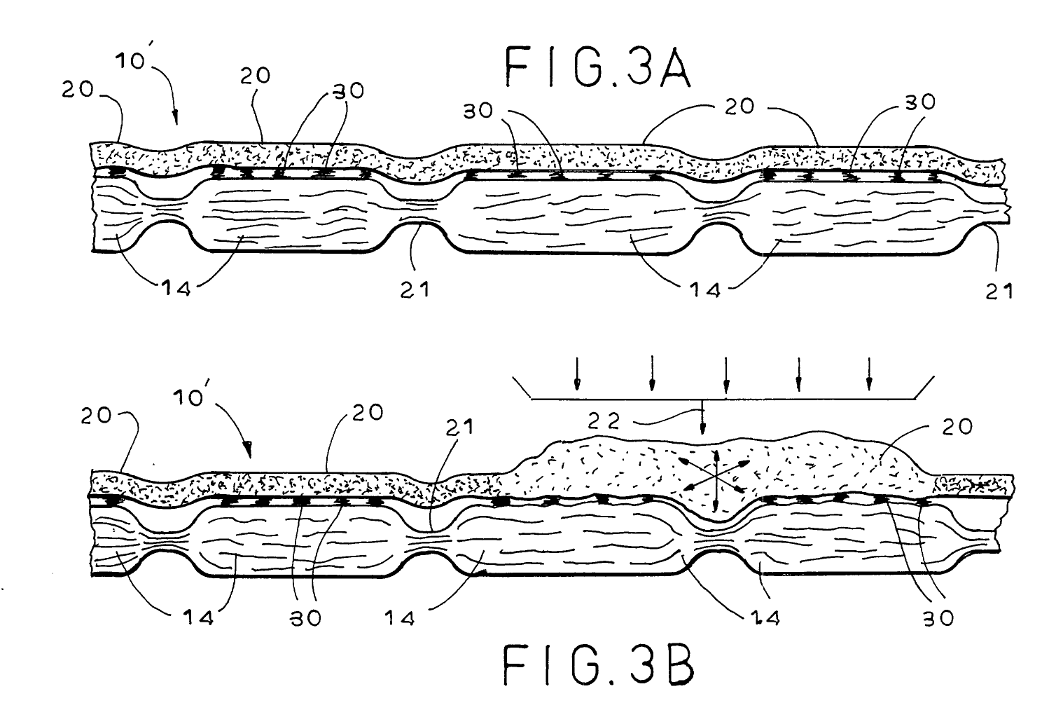

Referring now to FIGS. 3A and 3B in particular, therein illustrated is a barrier sheet according to a second preferred embodiment of the present invention, generally designated 10′. The barrier sheet 10′ of the second embodiment is essentially identical in structure to the barrier sheet 10 of the first embodiment (illustrated in FIGS. 1A through 2B) except for the absence of the proximal or upstream outer layer 12. Thus, the distal outer layer 14 of barrier sheet 10 becomes the first layer 14 of barrier sheet 10′, and the intermediate layer 20 of barrier sheet 10 becomes the second layer 20 of barrier sheet 10′. Accordingly, only a few brief comments need be directed to the second embodiment as follow:

The downstream layer 14 of breathable material preferably defines liquid-permeable pores therethrough. The second layer 20 of liquid-expandable material is disposed on and secured to the first layer 14 by elastic adhesive 30 (preferably in the form of a discontinuous layer), or by fusion bonding, etc. The second layer 20, prior to exposure of liquid, has a basis weight no greater than one of 15 gsm or 10% of the basis weight of the entire barrier sheet 10′ prior to exposure to liquid. The second layer 20 three dimensionally expands upon exposure to a liquid insult 22 to form a layer of material blocking the pores of the first layer 14 and increasing the liquid transmission resistance of the sheet 10′ in the direction of and at the point of liquid insult 22. The hydrohead of the sheet 10′ is at least 10 millibars in one direction and at least 25% (preferably at least 35%) greater than the hydrohead of the first layer 14 without the second layer 20.

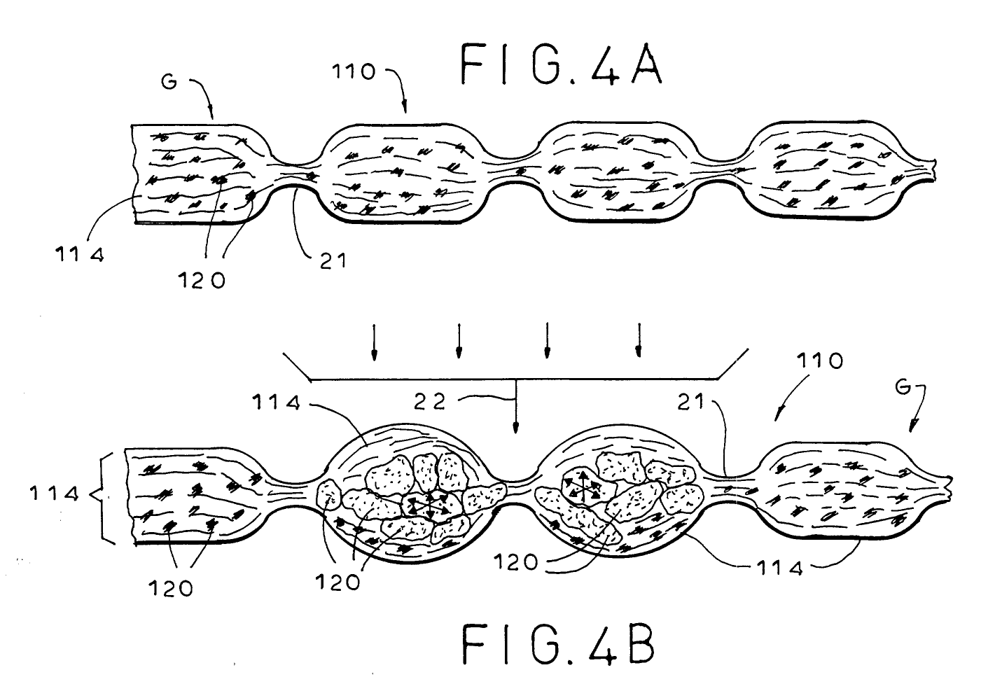

Referring now to FIGS. 4A and 4B in particular, therein illustrated is a disposable garment G including a barrier sheet according to a third preferred embodiment of the present invention, generally designated 110. The barrier sheet 110 of the third embodiment is essentially identical in structure to the barrier sheet 10′ of the second embodiment (illustrated in FIGS. 3A and 3B) except that the second material 120 is disposed within the first material 114. Thus, the first layer 14 of barrier sheet 10′ becomes the first material 114 of barrier sheet 110, and the second layer 20 of barrier sheet 10′ becomes the second material 120 of barrier sheet 110. Accordingly, only a few brief comments need be directed to the third embodiment as follows:

The barrier sheet 110 comprises a first material 114 which is breathable and defines liquid-permeable pores therethrough, and a second material 120. The second material 120 three dimensionally expands upon exposure to a liquid insult to form a layer of material blocking the pores of the first material 114 and increasing the liquid transmission resistance of said sheet is in the direction of and at the point of liquid insult.

The second material 120 is discontinuous (preferably formed of particles, fibers or the like) and in immediate physical contact with the first material 114, preferably dispersed therein. The second material 120 disposed in the first material 114 is preferably at least partially disposed adjacent the surface of the first material 114 to be initially exposed to liquid (that is, the proximal or upstream surface) and relatively remote from the opposite surface of the first material 114 (that is, the distal or downstream surface). After exposure to liquid in a given area, a substantial proportion of the pores of the first material 114 of the given area are blocked against liquid passage therethrough by the expanded second material 120.

The second material 120, prior to exposure to liquid, has a weight per unit area no greater than one of 15 gsm or 10% of the basis weight of the sheet 110 prior to exposure to liquid. The hydrohead of the sheet 110 is at least 10 millibars in one direction and at least 25% (preferably at least 35%) greater than the hydrohead of the first material 114 without the second material 120.

While the second preferred embodiment 10′ and the third preferred embodiment 110 of the barrier sheet have been described in general terms, without regard to the specific mechanism by which the second layer 20 or the second material 120, respectively, operate, the mechanism presumed hereinabove for operation of the intermediate layer 20 of the first embodiment 10 is also believed to be operable in the second and third embodiments 10′ and 110.

In each embodiment the desirable performance of the barrier breathability of the barrier sheet immediately decreasing in a given area upon a liquid insult to the barrier sheet in the given area. The breathability of the barrier sheet may be determined by the MVTR thereof or the air permeability thereof. More particularly, the barrier sheet prior to exposure to liquid is characterized by a permeability of at least one of an MVTR of at least 500 gsm/24 hours and an air permeability of at least 10 scfm/square foot, and upon exposure to liquid is characterized by a permeability of at least one of an MVTR of no more than 1,000 gsm/24 hours and an air permeability of no more than 10 scfm/square foot. Further, the barrier sheet has a hydrohead of at least 10 millibars in one direction.

For wearing comfort, an air permeability prior to liquid insult of at least 30 scfm/ft² (ASTM-D737-96 at an air pressure of 125 pa) is typically considered acceptable for a disposable barrier product such as a surgical gown. For barrier protection, a hydrostatic head of at least 65 mbar (EDANA 120.1-80) is typically considered acceptable for a disposable barrier garment such as a diaper, feminine hygiene product, surgical gown, etc., although special applications may require a higher head or permit a lower head. Each of the various embodiments of a barrier sheet according to the present invention is capable of meeting both of these wearing comfort and barrier protection criteria.

In determining hydrohead, the physical strength (e.g., tensile strength) of a thin barrier sheet may play a significant role. Thus, in low basis weight barrier sheets (especially one or two layer barrier sheets having a basis weight of less than 20 gsm), the physical integrity of the entangled fibers of the meltblown nonwoven of the barrier sheet may be disrupted by the liquid impact, thereby adversely affecting the liquid barrier property. But, of course, in many practical applications the barrier sheet will have its physical integrity buttressed by the presence of additional layers of material (e.g., nonwovens) on at least one side thereof and probably on both sides thereof.

### EXAMPLES

The following examples illustrate the efficacy of a barrier sheet according to the present invention.

The meltblown nonwoven used in each of the examples was formed from a polypropylene resin, available from Basell of Wilmington, Del. under the trade name HH442H and having a melt flow rate (230C, 2.16, ½ Orif) of approximately 1100. The meltblown nonwoven had a basis weight of 10.0 gsm and a fiber size of 2.0-5.0 um.

As these examples were conducted in a pilot plant facility, in order to facilitate manufacture and handling of the barrier sheet, a thin layer of an elastic hydrophobic hot melt adhesive, available from Henkel of Lewisville, Tex. under the trade name HM-6990, was applied to one meltblown nonwoven layer using a meltblown spray head, available from Nordson Corporation of Norcross, Ga. under the trade name MB 200. The adhesive layer had a basis weight of less than 1.0 gsm and was used to attach and secure the super-absorbent polymer particles to the downstream meltblown nonwoven layer.

### Example I

Three Layer Embodiment

Two outer layers of the above-identified meltblown nonwoven were assembled with an intermediate layer of liquid expandable material to form a barrier sheet according to the present invention. The intermediate layer was formed by a discontinuous layer of particles of a sodium polyacrylate super-absorbent polymer, available from Sumitomo Seika Chemicals of Osaka, Japan under the trade name AQUA KEEP 10 SH-NF, the intermediate layer having a basis weight of 3.5 gsm and a particle size of 106 μm or less.

The various layers were thermobonded together using a calender (having an engraved roll and a smooth roll) to produce a bonding area of 17.5% and 100 points/cm². The bonding temperature was set at an oil temperature of 115 C.

As a control, two outer layers of the above-identified meltblown nonwovens were similarly thermobonded together, but without the intermediate liquid-expandable layer or the adhesive layer.

Twelve specimens were tested for air permeability prior to liquid insult pursuant to ASTM-D737-96 (at an air pressure of 125 pa) and hydrostatic head pursuant to EDANA 120.1-80. The averaged results are illustrated in the Table I below:

TABLE I

| | Example I | Control |
|---|---|---|
| Air Permeability, cfm/ft² | 45 | 49 |
| Hydrostatic Head, mbar | 86.3 | 62 |

The data of Table I shows that the barrier sheet according to the present invention provided a 39% improvement in hydrostatic head (relative to the control) with a relatively insignificant difference in air permeability. Generally any air permeability over 30 cfm/ft² is considered acceptable for such barrier products as surgical gowns.

### Example II

Two Layer Embodiment

A two layer embodiment of the barrier sheet according to the present invention was formed exactly like the three layer embodiment described in Example I except that there was only one layer of meltblown nonwoven and the layer of liquid expandable material was loosely covered (without securement or attachment to the liquid expandable layer) by a protective covering. The protective covering was a hydrophobic polypropylene spunbond with a basis weight of 13.5 gsm available from First Quality Nonwovens, Inc. of Hazleton, Pa. The protective covering was interposed so as to be between the fluid impact and the test specimen, thereby to preclude any damage to the liquid expandable layer during either air permeability or hydrostatic head testing.

As a control, a layer of the above-identified meltblown nonwoven was loosely covered with the same protective covering.

Twelve specimens of the barrier sheet of the present invention and the control were tested for air permeability and hydrostatic head as in Example I. The averaged results are indicated in Table II below:

TABLE II

| | Example I | Control |
|---|---|---|
| Air permeability, cfm/ft² | 60 | 70 |
| Hydrostatic Head, mbar | 47 | 34 |

The data of Table II shows that the barrier sheet according to the present invention provided a 38% improvement in hydrostatic head (relative to the control) with a relatively insignificant difference in air permeability. Specimens subjected to a higher hydrostatic head evidenced under microscopic examination a disruption of the physical integrity of the meltblown nonwoven layer of the specimen.

To summarize, the present invention provides a barrier sheet/disposable garment which affords a high level of comfort and a high level of barrier protection, and more particularly, a high level of comfort prior to a liquid insult and a high level of barrier protection upon and after a liquid insult. The barrier sheet/disposable garment achieves this by demonstrating a variable porosity. The barrier sheet/disposable garment is simple and economical to manufacture and use.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

We claim:

1. A barrier sheet comprising:
(A) a first outer layer of breathable material,
(B) a second outer layer of breathable material, at least one of said first and second outer layers defining liquid-permeable pores therethrough, and
(C) a layer of material disposed intermediate said first and second outer layers, said intermediate layer being three dimensionally expandable upon exposure to a liquid insult to form a layer of material blocking said pores of at least one of said first and second outer layers and increasing the liquid transmission resistance of said sheet in the direction of and at the point of liquid insult;
said first and second outer layer being secured together with said intermediate layer therebetween;
said sheet prior to exposure to liquid being characterized by a permeability of at least one of an MVTR of at least 500 gsm/24 hrs and an air permeability of at least 10 scfm/square foot; and
said intermediate layer prior to exposure to liquid having a basis weight no greater than one of 15 gsm and 10% of the basis weight of said sheet prior to exposure to liquid.

2. The barrier sheet of claim 1 having a hydrohead of at least 10 millibars in one direction.

3. The barrier sheet of claim 1 having a hydrohead which is at least 25% greater than the hydrohead of a barrier sheet consisting of said first and second outer layers secured together without said intermediate layer.

4. The barrier sheet of claim 1 wherein said intermediate layer has a basis weight no greater than 10 gsm.

5. The barrier sheet of claim 4 wherein said intermediate layer has a basis weight no greater than 5 gsm.

6. The barrier sheet of claim 5 wherein said intermediate layer has a basis weight no greater than 3 gsm.

7. The barrier sheet of claim 6 wherein said intermediate layer has a basis weight no greater than 2 gsm.

8. The barrier sheet of claim 1 wherein a distal outer layer is the last of said outer layers to be exposed to liquid and defines liquid-permeable pores therethrough, and, after exposure to liquid in a given area thereof, a substantial proportion of said pores of said distal outer layer in the given area are infiltrated and blocked against liquid passage therethrough by portions of said intermediate layer.

9. The barrier sheet of claim 8 wherein said distal outer layer is in immediate physical contact with said intermediate layer.

10. The barrier sheet of claim 9 wherein essentially the entire adjacent surfaces of said distal outer layer and said intermediate layer are in immediate physical contact.

11. The barrier sheet of claim 1 wherein said outer layers are independently selected from the group consisting of wovens, nonwovens, microporous films, and combinations thereof.

12. The barrier sheet of claim 11 wherein at least one of said outer layers is a meltblown nonwoven.

13. The barrier sheet of claim 12 wherein both of said outer layers are meltblown nonwovens.

14. The barrier sheet of claim 1 wherein said intermediate layer is discontinuous.

15. The barrier sheet of claim 14 wherein said intermediate layer is formed of particles.

16. The barrier sheet of claim 14 wherein said intermediate layer is formed of fibers.

17. The barrier sheet of claim 1 wherein said intermediate layer is a material capable of expanding in volume by a factor of at least 2 upon exposure to sufficient liquid.

18. The barrier sheet of claim 17 wherein said intermediate layer is formed of super-absorbent polymer.

19. The barrier sheet of claim 1 wherein said intermediate layer is a thin layer of solid material which is essentially instantaneously expandable upon exposure to liquid.

20. The barrier sheet of claim 1 wherein said intermediate layer is expandable to form a gel-like layer upon exposure to liquid.

21. The barrier sheet of claim 1 wherein said intermediate layer has a basis weight no greater than 5% of the basis weight of said sheet prior to exposure to liquid.

22. The barrier sheet of claim 21 wherein said intermediate layer has a basis weight no greater than 4% of the basis weight of said sheet prior to exposure to liquid.

23. The barrier sheet of claim 22 wherein said intermediate layer has a basis weight no greater than 2% of the basis weight of said sheet prior to exposure to liquid.

24. The barrier sheet of claim 23 wherein said intermediate layer has a basis weight no greater than 1% of the basis weight of said sheet prior to exposure to liquid.

25. The barrier sheet of claim 1 wherein said sheet is flexible.

26. The barrier sheet of claim 1 wherein said outer layers are secured together by an elastic adhesive.

27. The barrier sheet of claim 26 wherein said elastic adhesive is in the form of a discontinuous layer.

28. The barrier sheet of claim 1 wherein said outer layers are secured together by fusion bonding.

29. The barrier sheet of claim 1 wherein said intermediate layer is formed of a liquid-expandable material selected from the group consisting of starch, gelatin, viscose, pulp, cotton, water-insoluble polymers, and combinations thereof.

30. The barrier sheet of claim 1 wherein said sheet prior to exposure to liquid is characterized by a permeability of at least one of an MVTR of about 500-5,000 gsm/24 hrs and an air permeability of about 10-1,000 scfm/square foot.

31. The barrier sheet of claim 1 wherein said formed layer is an essentially continuous, film-like, substantially liquid-impermeable layer.

32. The barrier sheet of claim 1 wherein said formed layer is discontinuous.

33. A disposable garment including the barrier sheet of claim 1.

34. A barrier sheet consisting of:
(A) a first layer of breathable material defining liquid-permeable pores therethrough, and
(B) a second layer of material disposed on and secured to said first layer, said second layer being three dimensionally expandable upon exposure to a liquid insult to form a layer of material blocking said pores of said first layer and increasing the liquid transmission resistance of said sheet in the direction of and at the point of liquid insult;
said sheet prior to exposure to liquid being characterized by a permeability of at least one of an MVTR of at least 500 gsm/24 hrs and an air permeability of at least 10 scfm/square foot; and
said second layer prior to exposure to liquid having a basis weight no greater than one of 15 gsm or 10% of the basis weight of said sheet prior to exposure to liquid.

35. The barrier sheet of claim 34 having a hydrohead of at least 10 millibars in one direction.

36. The barrier sheet of claim 34 having a hydrohead which is at least 25% greater than the hydrohead of said first layer without said second layer.

37. The barrier sheet of claim 34 wherein said second layer has a basis weight no greater than 10 gsm.

38. The barrier sheet of claim 37 wherein said second layer has a basis weight no greater than 5 gsm.

39. The barrier sheet of claim 34 wherein said first layer is the last of said layers to be exposed to liquid, and, after exposure to liquid in a given area thereof, a substantial proportion of said pores of said first layer in the given area are infiltrated and blocked against liquid passage therethrough by portions of said second layer.

40. The barrier sheet of claim 39 wherein said first layer is in immediate physical contact with said second layer.

41. The barrier sheet of claim 40 wherein essentially the entire adjacent surfaces of said distal outer layer and said intermediate layer are in immediate physical contact.

42. The barrier sheet of claim 34 wherein said first layer is selected from the group consisting of wovens, nonwovens, microporous films, and combinations thereof.

43. The barrier sheet of claim 42 wherein said first layer is a meltblown nonwoven.

44. The barrier sheet of claim 42 wherein said first layer is a spunbond nonwoven.

45. The barrier sheet of claim 34 wherein said second layer is discontinuous.

46. The barrier sheet of claim 45 wherein said second layer is formed of particles.

47. The barrier sheet of claim 45 wherein said second layer is formed of fibers.

48. The barrier sheet of claim 34 wherein said second layer is a material capable of expanding in volume by a factor of at least 2 upon exposure to sufficient liquid.

49. The barrier sheet of claim 48 wherein said second layer is formed of super-absorbent polymer.

50. The barrier sheet of claim 34 wherein said second layer is a thin layer of solid material which is essentially instantaneously expandable upon exposure to liquid.

51. The barrier sheet of claim 34 wherein said second layer is expandable to form a gel-like layer upon exposure to liquid.

52. The barrier sheet of claim 34 wherein said second layer has a basis weight no greater than 5% of the basis weight of said sheet prior to exposure to liquid.

53. The barrier sheet of claim 52 wherein said second layer has a basis weight no greater than 4% of the basis weight of said sheet prior to exposure to liquid.

54. The barrier sheet of claim 53 wherein said second layer has a basis weight no greater than 2% of the basis weight of said sheet prior to exposure to liquid.

55. The barrier sheet of claim 54 wherein said second layer has a basis weight no greater than 1% of the basis weight of said sheet prior to exposure to liquid.

56. The barrier sheet of claim 34 wherein said sheet is flexible.

57. The barrier sheet of claim 34 wherein said first and second layers are secured together by an elastic adhesive.

58. The barrier sheet of claim 57 wherein said elastic adhesive is in the form of a discontinuous layer.

59. The barrier sheet of claim 57 wherein said first and second layers are secured together by fusion bonding.

60. The barrier sheet of claim 34 wherein said second layer is a liquid-expandable material selected from the group consisting of starch, gelatin, viscose, pulp, cotton, water-insoluble polymers, and combinations thereof.

61. The barrier sheet of claim 34 wherein said sheet prior to exposure to liquid is characterized by a permeability of at least one of an MVTR of about 500-5,000 gsm/24 hrs and an air permeability of about 10-1,000 scfm/square foot.

62. The barrier sheet of claim 34 wherein said second layer has a basis weight no greater than 3 gsm.

63. The barrier sheet of claim 34 wherein said second layer has a basis weight no greater than 2 gsm.

64. The barrier sheet of claim 34 wherein said formed layer is an essentially continuous, film-like, substantially liquid-impermeable layer.

65. The barrier sheet of claim 34 wherein said formed layer is discontinuous.

66. A disposable garment including the barrier sheet of claim 31.

67. A disposable garment including a barrier sheet comprising:
(A) a first material which is breathable and defines liquid-permeable pores therethrough, and
(B) a second material, said second material being three dimensionally expandable upon exposure to a liquid insult to form a layer of material blocking said pores of said first layer and increasing the liquid transmission resistance of said sheet in the direction of and at the point of liquid insult;
said second material being disposed in said first material;
said sheet prior to exposure to liquid being characterized by a permeability of at least one of an MVTR of at least 500 gsm/24 hrs and an air permeability of at least 10 scfm/square foot; and
said second material prior to exposure to liquid having a weight no greater than one of 15 gsm and 10% of the basis weight of said sheet prior to exposure to liquid.

68. The disposable garment of claim 67 wherein said sheet has a hydrohead of at least 10 millibars in one direction.

69. The disposable garment of claim 67 wherein said sheet has a hydrohead which is at least 25% greater than the hydrohead of said first material only.

70. The disposable garment of claim 67 wherein said second material has a basis weight no greater than 10 gsm.

71. The disposable garment of claim 70 wherein said second material has a basis weight no greater than 5 gsm.

72. The disposable garment of claim 67 wherein said second material is at least partially disposed adjacent the surface of said first material to be initially exposed to liquid and relatively remote from the opposite surface of said first material, and, after exposure to liquid in a given area, a substantial proportion of such pores of said first material in the given area are infiltrated and blocked against liquid passage therethrough by portions of said second material.

73. The disposable garment of claim 72 wherein said first and second materials are in immediate physical contact.

74. The disposable garment of claim 67 wherein said first material is selected from the group consisting of wovens, nonwovens, microporous films, and combinations thereof.

75. The disposable garment of claim 74 wherein said first material is a meltblown nonwoven.

76. The disposable garment of claim 74 wherein said first material is a spunbond nonwoven.

77. The disposable garment of claim 67 wherein said second material is discontinuous.

78. The disposable garment of claim 77 wherein said second material is formed of particles.

79. The disposable garment of claim 77 wherein said second material is formed of fibers.

80. The disposable garment of claim 67 wherein said second material is a material capable of expanding in volume by a factor of at least 2 upon exposure to sufficient liquid.

81. The disposable garment of claim 80 wherein said second material is formed of super-absorbent polymer.

82. The disposable garment of claim 67 wherein said second material is a thin layer of solid material which is essentially instantaneously expandable upon exposure to liquid.

83. The disposable garment of claim 67 wherein said second material is expandable to form a gel-like layer upon exposure to liquid.

84. The disposable garment of claim 67 wherein said second material has a weight no greater than 5% of the weight of said sheet prior to exposure to liquid.

85. The disposable garment of claim 84 wherein said second material has a weight no greater than 4% of the weight of said sheet prior to exposure to liquid.

86. The disposable garment of claim 85 wherein said second material has a weight no greater than 2% of the weight of said sheet prior to exposure to liquid.

87. The disposable garment of claim 86 wherein said second material has a weight no greater than 1% of the weight of said sheet prior to exposure to liquid.

88. The of claim 67 wherein said sheet is flexible.

89. The disposable garment of claim 67 wherein said second material is dispersed within and physically entrapped by said first material.

90. The disposable garment of claim 67 wherein said second material is selected from the group consisting of starch, gelatin, viscose, pulp, cotton, water-insoluble polymers, and combinations thereof.

91. The disposable garment of claim 67 wherein said sheet prior to exposure to liquid is characterized by a permeability of at least one of an MVTR of about 500-5,000 gsm/24 hrs and an air permeability of about 10-1,000 scfm/square foot.

92. The disposable garment of claim 67 wherein said second material has a basis weight no greater than 3 gsm.

93. The disposable garment of claim 92 wherein said second material has a basis weight no greater than 2 gsm.

94. The disposable garment of claim 67 wherein said formed layer is an essentially continuous, film-like, substantially liquid-impermeable layer.

95. The disposable garment of claim 67 wherein said formed layer is discontinuous.

96. A barrier sheet characterized by a variable level of breathability, the breathability of the barrier sheet substantially decreasing in a given area upon a liquid insult to the barrier sheet in the given area.

97. The barrier sheet of claim 96 wherein the breathability of the barrier sheet is determined by the MVTR thereof.

98. The barrier sheet of claim 96 wherein the breathability of the barrier sheet is determined by the air permeability thereof.

99. The barrier sheet of claim 96 wherein the barrier sheet prior to exposure to liquid is characterized by a permeability of at least one of an MVTR of at least 500 gsm/24 hours and an air permeability of at least 10 scfm/square foot, and upon exposure to liquid is characterized by a permeability of at least one of an MVTR of no more than 1,000 gsm/24 hours and an air permeability of no more than 10 scfm/square foot.

100. The barrier sheet of claim 96 having a hydrohead of at least 10 millibars in one direction.

101. The barrier sheet of claim 96 comprising:
(A) a first outer layer of breathable material,
(B) a second outer layer of breathable material, at least one of said first and second outer layers defining liquid-permeable pores therethrough, and
(C) a layer of material disposed intermediate said first and second outer layers, said intermediate layer being three dimensionally expandable upon exposure to a liquid insult to form a layer of material blocking said pores of at least one of said first and second outer layers and increasing the liquid transmission resistance of said sheet in the direction of and at the point of liquid insult;
said first and second outer layer being secured together with said intermediate layer therebetween;
said sheet prior to exposure to liquid being characterized by a permeability of at least one of an MVTR of at least 500 gsm/24 hrs and an air permeability of at least 10 scfm/square foot; and
said intermediate layer prior to exposure to liquid having a basis weight no greater than one of 15 gsm and 10% of the basis weight of said sheet prior to exposure to liquid.

102. The barrier sheet of claim 101 wherein said intermediate layer clogs said pores of said at least one outer layer upon exposure to liquid.

103. A disposable garment including the barrier sheet of claim 101.

104. The barrier sheet of claim 96 consisting of:
(A) a first layer of breathable material defining liquid-permeable pores therethrough, and
(B) a second layer of material disposed on and secured to said first layer, said second layer being three dimensionally expandable upon exposure to a liquid insult to form a layer of material blocking said pores of said first layer and increasing the liquid transmission resistance of said sheet in the direction of and at the point of liquid insult;
said sheet prior to exposure to liquid being characterized by a permeability of at least one of an MVTR of at least 500 gsm/24 hrs and an air permeability of at least 10 scfm/square foot; and
said second layer prior to exposure to liquid having a basis weight no greater than one of 15 gsm and 10% of the basis weight of said sheet prior to exposure to liquid.

105. The barrier sheet of claim 104 wherein said second layer clogs said pores upon exposure to liquid.

106. A disposable garment including the barrier sheet of claim 105.

107. A disposable garment including a barrier sheet comprising:
(A) a first material which is breathable and defines liquid-permeable pores therethrough, and
(B) a second material, said second material being three dimensionally expandable upon exposure to a liquid insult to form a layer of material blocking said pores of said first layer and increasing the liquid transmission resistance of said sheet in the direction of and at the point of liquid insult;
said second material being disposed in said first material;
said sheet prior to exposure to liquid being characterized by a permeability of at least one of an MVTR of at least 500 gsm/24 hrs and an air permeability of at least 10 scfm/square foot; and
said second material prior to exposure to liquid having a weight no greater than one of 15 gsm and 10% of the basis weight of said sheet prior to exposure to liquid.

108. The disposable garment of claim 107 wherein said second material clogs said pores upon exposure to liquid.
